(19) United States
(12) Patent Application Publication
(10) Pub. No.: US 2015/0338555 A1
(43) Pub. Date: Nov. 26, 2015

(54) OPTICAL FIBER COATING WITH NON-RADIATION-CURABLE ACRYLIC HARD-SOFT BLOCK COPOLYMER

(71) Applicant: Corning Incorporated, Corning, NY (US)

(72) Inventors: Dana Craig Bookbinder, Corning, NY (US); Weijun Niu, Painted Post, NY (US); Kevin Robert McCarthy, Horseheads, NY (US); David Neal Schissel, Painted Post, NY (US); Arthur Lawrence Wallace, Corning, NY (US)

(21) Appl. No.: 14/590,281

(22) Filed: Jan. 6, 2015

Related U.S. Application Data
(60) Provisional application No. 61/925,795, filed on Jan. 10, 2014.

(51) Int. Cl. G02B 1/14; C03C 25/10

(52) U.S. Cl. CPC G02B 1/14; C03C 25/106

(57) ABSTRACT

An optical fiber coating composition that includes an acrylic copolymer. The acrylic copolymer is a block copolymer that includes two or more acrylic blocks. The two or more acrylic blocks differ in glass transition temperature (T_{g}). The acrylic copolymer may include an acrylic block with a T_{g} above 50° C. and an acrylic block with a T_{g} below 0° C. Representative monomers from which the repeat units of the acrylic blocks are derived include alkyl(meth)acrylates. In one embodiment, the acrylic copolymer includes an acrylic block with repeat units derived from methylmethacrylate and an acrylic block derived from butylacrylate. The acrylic copolymer lacks urethane groups, lacks urea groups, lacks radiation-curable groups, and is otherwise unreactive with other components in the coating composition. The acrylic copolymer features high solubility in common acrylate-based radiation-curable coating compositions and can be provided at high concentrations in acrylate-based coating compositions.

This application claims the benefit of priority under 35 U.S.C. §119 of U.S. Provisional Application Ser. No. 61/925,795 filed on Jan. 10, 2014, the content of which is relied upon and incorporated herein by reference in its entirety.

### FIELD

The present disclosure relates to compositions used to form coatings for optical fibers. More particularly, this disclosure relates to coating compositions and coatings based on radiation-curable monomers and/or crosslinkers that include a non-radiation-curable acrylic copolymer.

### TECHNICAL BACKGROUND

The light transmitting performance of an optical fiber is highly dependent upon the properties of the polymer coating that is applied to the fiber during manufacturing. Typically a dual-layer coating system is used where a softer primary coating is in contact with the glass fiber and a harder secondary coating surrounds the primary coating. The harder secondary coating allows the fiber to be handled and further processed, while the softer primary coating plays a key role in dissipating external forces and preventing them from being transferred to the fiber where they can cause microbend induced light attenuation.

The functional requirements of the primary coating place various requirements on the materials that are used for these coatings. The Young's modulus of the primary coating is generally less than 1 MPa, and is ideally less than 0.5 MPa. The glass transition temperature of the primary coating is less than 0° C., and is ideally less than −20° C. to ensure that the primary coating remains soft when the fiber is subjected to low temperatures. In order to ensure uniform deposition on the fiber, the primary coating is applied to the fiber in liquid form and must quickly form a solid having sufficient integrity to support application of the outer secondary coating. Also, the tensile strength of the primary coating, which generally decreases as the modulus decreases, must be high enough to prevent tearing defects during on draw processing or subsequent processing of the coated fiber during cabling, etc.

In order to meet these requirements, optical fiber coatings are usually formulated as mixtures of radiation curable urethane/acrylate oligomers and radiation curable acrylate functional diluents. Upon exposure to light in the presence of a photoinitiator, the acrylate groups rapidly polymerize to form a crosslinked polymer network which is further strengthened by hydrogen bonding interactions between urethane groups along the oligomer backbone. By varying the urethane/acrylate oligomer, it is possible to form coatings having very low modulus values while still maintaining sufficient tensile strength. Numerous optical fiber coating formulations have been disclosed in which the composition of the radiation-curable urethane/acrylate oligomer has been varied to achieve different property targets.

Radiation-curable optical fiber coatings having low modulus values and low glass transition temperatures can be prepared using acrylate functional oligomers alone, such as polyalkylene glycol diacrylates, but such coatings typically have very poor tensile strength due to the absence of the reinforcing urethane groups found in the more commonly used coatings. The use of a non-radiation-curable thermoplastic elastomer as a toughening additive in a crosslinked radiation curable all acrylic optical fiber coating has been disclosed in U.S. Pat. No. 6,810,187. Specifically disclosed are block copolymers comprising a thermoplastic polyurethane, styrene butadiene, EPDM, ethylene propylene rubber, synthetic styrene butadiene rubber, styrenic block compolymers or combinations, where the elastomeric soft block comprises a polybutadiene, hydrogenated polybutadiene, polyisoprene, polyethylene/butylene, polyethylene/propylene, diol block or combinations thereof.

However, the nature of these thermoplastic elastomers may limit their solubility in, and consequently their ability to toughen, a typical fiber coating composition based on acrylic monomers. Solid, high molecular weight thermoplastic urethane elastomers are insoluble or sparingly soluble in most acrylic monomers. The poor solubility limits the amount of thermoplastic elastomer that can be used as a toughening additive in a coating formulation. Slightly higher solubility of thermoplastic urethane elastomers is observed in highly polar acrylic monomers, but such monomers are expensive and the solubility remains well below the levels desired for a practical coating composition. Many highly polar acrylic monomers are also known to cause excessive smoking during the coating operation when drawn on optical fiber. Other elastomer additives, such as those based on butadiene or other hydrocarbon-like soft blocks, are only soluble in highly non-polar monomers, such as lauryl acrylate, isodecyl acrylate or tridecyl acrylate, which are known to inhibit fiber coating curing speeds. Also, the increase in coating viscosity resulting from addition of larger amounts of a high molecular weight elastomer with only limited solubility in the coating monomer is often detrimental to the coating operation.

There remains a need for coating formulation additives that enable economical primary coating materials that possess low modulus and high tensile strength.

### SUMMARY

This disclosure provides a coating composition for optical fibers, coatings formed from the compositions, fibers coated with the coating formed from the compositions, and methods of forming coatings on fibers with compositions.

The disclosure includes a radiation-curable optical fiber coating which contains one or more non-reactive acrylic copolymer materials as additives, where the non-reactive copolymer(s) include at least one all acrylic hard block and one all acrylic soft block, and lack a radiation-curable functional group. The non-reactive, non-radiation-curable acrylic copolymer(s) are also free of urethane/urea group containing materials. The non-reactive, non-radiation-curable acrylic copolymer may be used as a reinforcing agent in a low modulus, crosslinked acrylic coating prepared by radiation curing a composition that includes a photoinitiator and one or more monofunctional radiation-curable monomers and/or one or more multi-functional radiation-curable components. The multi-functional radiation-curable component may be a multi-functional radiation-curable monomer. The multi-functional radiation-curable component may be a multi-functional radiation-curable oligomer.

In one embodiment, the coating composition includes a radiation-curable component, an acrylic copolymer, and a photoinitiator. The radiation-curable component may include one or more monomers, one or more oligomers, or a combination of one or more monomers and one or more oligomers. The monomers may function as reactive diluents in the coating composition. The radiation-curable component includes a radiation-curable functional group. The radiation-curable group may be an ethylenically unsaturated group, such as an acrylate or methacrylate group. The radiation-curable component may be monofunctional or multifunctional.

In one embodiment, the acrylic copolymer is a block copolymer that includes two or more blocks, where each block is based on a repeat unit derived from a different acrylic monomer. Homopolymers formed from the acrylic monomers from which the two or more acrylic blocks are derived differ in glass transition temperature (T_{g}). In one embodiment, the homopolymer of the monomer used to form one block of the acrylic copolymer has a T_{g} above room temperature and the homopolymer of the monomer used to form another block of the acrylic copolymer has a T_{g} below room temperature. The difference in T_{g} of the homopolymers obtained from the different monomers used to form two acrylic blocks of the acrylic copolymer may be at least 50° C. The acrylic copolymer lacks urethane groups, lacks urea groups, and lacks radiation-curable groups. The acrylic copolymer is non-reactive with other components of the coating composition.

In one embodiment, the coating composition includes 5-40 wt % of one or more non-radiation-curable acrylic copolymers, 0.5-10 wt % of one or more multifunctional radiation-curable components, 40-80 wt % of one or more monofunctional radiation-curable components, and 0.5-5 wt % of photoinitiator.

The present disclosure extends to:

An optical fiber coating composition comprising:

a radiation-curable component;

a photoinitiator; and

a non-radiation-curable acrylic copolymer, said acrylic copolymer lacking urethane groups and urea groups, said acrylic copolymer comprising a first acrylic block and a second acrylic block, said first acrylic block including repeat units derived from a first acrylic monomer, said second acrylic block including repeat units derived from a second acrylic monomer, said second acrylic monomer differing from said first acrylic monomer.

Additional features and advantages will be set forth in the detailed description which follows, and in part will be readily apparent to those skilled in the art from the description or recognized by practicing the embodiments as described in the written description and claims hereof.

It is to be understood that both the foregoing general description and the following detailed description are merely exemplary, and are intended to provide an overview or framework to understand the nature and character of the claims.

### DETAILED DESCRIPTION

The present disclosure provides a coating composition and coating for optical fibers. The coating composition is radiation-curable and, upon curing, forms a fiber coating that has low modulus and high tensile strength. The present disclosure extends to a fiber coated with a coating formed from the coating composition and a method of coating a fiber with the coating composition.

In one embodiment, the coating composition includes a radiation-curable component, an acrylic copolymer, and a photoinitiator. The radiation-curable component may include one or more monomers, one or more oligomers, or a combination of one or more monomers and one or more oligomers. The monomers may function as reactive diluents in the coating composition and may afford control over the viscosity of the coating composition to facilitate processing. The radiation-curable component includes a radiation-curable functional group. The radiation-curable group may be an ethylenically unsaturated group, such as an acrylate or methacrylate group. The radiation-curable component may be monofunctional or multifunctional. Multifunctional radiation-curable components may be referred to herein as “crosslinkers”. The monofunctional or multifunctional radiation-curable component may have a molecular weight of less than 3000 g/mol, or less than 2500 g/mol, or less than 2000 g/mol, or less than 1500 g/mol, or less than 1000 g/mol.

The radiation-curable component may include a radiation-curable monofunctional or multifunctional monomer. The monomer may include a monofunctional or multifunctional (meth)acrylate monomer. As used herein, the term “(meth)acrylate” means acrylate or methacrylate. The monomer may include polyether (meth)acrylates, polyester (meth)acrylates, or polyol (meth)acrylates. The multifunctional monomer may be a di(meth)acrylate, tri(meth)acrylate, tetra(meth)acrylate, or higher (meth)acrylate. Monofunctional or multifunctional polyol (meth)acrylates may include monofunctional or multifunctional polyalkoxy(meth)acrylates (e.g. polyethyleneglycol diacrylate, polypropylene glycol diacrylate).

Radiation-curable monomers may also include ethylenically-unsaturated compounds, ethoxylated (meth)acrylates, ethoxylated alkylphenol mono(meth)acrylates, propylene oxide (meth)acrylates, n-propylene oxide (meth)acrylates, isopropylene oxide (meth)acrylates, monofunctional (meth)acrylates, monofunctional aliphatic epoxy (meth)acrylates, multifunctional (meth)acrylates, multifunctional aliphatic epoxy (meth)acrylates, and combinations thereof. The monomer component may include compounds having the general formula R₂—R₁—O—(CH₂CH(CH₃)—O)ₙ—COCH═CH₂, where R₁ and R₂ are aliphatic, aromatic, or a mixture of both, and n=1 to 10, or R₁—O—(CH₂CH(CH₃)—O)ₙ—COCH═CH₂, where R₁ is aliphatic or aromatic, and n=1 to 10, or formula R₂—R₁—O—(CH₂CH₂—O)ₙ—COCH═CH₂, where R₁ and R₂ are aliphatic, aromatic, or a mixture of both, and n=1 to 10, or R₁—O—(CH₂CH₂—O)ₙ—COCH═CH₂, where R₁ is aliphatic or aromatic, and n=1 to 10.

Representative radiation-curable monomers include ethylenically unsaturated monomers such as ethylhexyl acrylate, lauryl acrylate (e.g., SR335, Sartomer USA (Exton, Pa.), AGEFLEX FA12, BASF, and PHOTOMER 4812, IGM Resins (St. Charles, Ill.), ethyoxylated lauryl acrylate (e.g. CD9075, Sartomer USA (Exton, Pa.), ethoxylated nonylphenol acrylate (e.g., SR504, Sartomer USA (Exton, Pa.) and PHOTOMER 4066 available from IGM Resins (St. Charles, Ill.)), caprolactone acrylate (e.g., SR495, Sartomer USA (Exton, Pa.), and TONE M-100 available from Dow Chemical), phenoxyethyl acrylate (e.g., SR339, Sartomer USA (Exton, Pa.), AGEFLEX PEA available from BASF, and PHOTOMER 4035 available from IGM Resins (St. Charles, Ill.)), isooctyl acrylate (e.g., SR440, Sartomer USA (Exton, Pa.) and AGEFLEX FAB, BASF), tridecyl acrylate (e.g., SR489, Sartomer USA (Exton, Pa.)), isobornyl acrylate (e.g., SR506, Sartomer USA (Exton, Pa.) and AGEFLEX IBOA, CPS Chemical Co.), tetrahydrofurfuryl acrylate (e.g., SR285, Sartomer USA (Exton, Pa.)), stearyl acrylate (e.g., SR257, Sartomer USA (Exton, Pa.)), isodecyl acrylate (e.g., SR395, Sartomer USA (Exton, Pa.) and AGEFLEX FA10, BASF), 2-(2-ethoxyethoxyl)ethyl acrylate (e.g., SR256, Sartomer USA (Exton, Pa.)), epoxy acrylate (e.g., CN120, Sartomer USA (Exton, Pa.), and EBECRYL 3201 and 3604, Cytec Industries Inc. (Woodland Park, N.J.)), lauryloxyglycidyl acrylate (e.g., CN130, Sartomer USA (Exton, Pa.)) and phenoxyglycidyl acrylate (e.g., CN131, Sartomer USA (Exton, Pa.)) and combinations thereof.

The radiation-curable component of the coating composition may include a multifunctional (meth)acrylate monomer. Multifunctional (meth)acrylates are (meth)acrylates having two or more polymerizable (meth)acrylate moieties per molecule. The multifunctional (meth)acrylate may have three or more polymerizable (meth)acrylate moieties per molecule. The multifunctional (meth)acrylate may have four or more polymerizable (meth)acrylate moieties per molecule.

Examples of multifunctional (meth)acrylates include dipentaerythritol monohydroxy pentaacrylate (e.g. PHOTOMER 4399, IGM Resins (St. Charles, Ill.)); methylolpropane polyacrylates with and without alkoxylation such as trimethylolpropane triacrylate (e.g. SR 351, Sartomer USA (Exton, Pa.), ditrimethylolpropane tetraacrylate (e.g., PHOTOMER 4355, IGM Resins (St. Charles, Ill.)); alkoxylated glyceryl triacrylates such as propoxylated glyceryl triacrylate with propoxylation being 3 or greater (e.g., PHOTOMER 4096, IGM Resins (St. Charles, Ill.)); triproplyleneglycol diacrylate (e.g. SR306, Sartomer USA (Exton, Pa.)); dipropylene glycol diacrylate (e.g. SR508, Sartomer USA (Exton, Pa.)); and erythritol polyacrylates with and without alkoxylation, such as pentaerythritol tetraacrylate (e.g., SR295, Sartomer USA (Exton, Pa.)), ethoxylated pentaerythritol tetraacrylate (e.g., SR494, Sartomer USA (Exton, Pa.)), and dipentaerythritol pentaacrylate (e.g., PHOTOMER 4399, IGM Resins (St. Charles, Ill.), and SR399, Sartomer USA (Exton, Pa.)).

Unless otherwise specified or implied herein, the weight percent (wt %) of a particular component in the coating composition refers to the amount of the component present in the curable composition on an additive-free basis. Generally, the weight percents of the radiation-curable component(s), copolymer(s) and initiator(s) sum to 100%. When present, the amount of an additive is reported herein in units of parts per hundred (pph) relative to the combined amounts of radiation-curable component(s), copolymer(s), and initiator(s). An additive present at the 1 pph level, for example, is present in an amount of 1 g for every 100 g of combined radiation-curable component(s), copolymer(s), and initiator(s). The weight percent of a constituent of the present coating compositions may also be referred herein as the concentration of the constituent.

A multifunctional radiation-curable component may be present in the radiation-curable coating composition at a concentration of from 0.05-15 wt %, or from 0.1-10 wt %, or from 0.5-10 wt %, or from 1-10 wt %, or from 2-8 wt %, or from 1-5 wt %, or from 1-50 wt % or from 5-40 wt %.

The radiation-curable component of the coating composition may include an N-vinyl amide such as an N-vinyl lactam, or N-vinyl pyrrolidinone, or N-vinyl caprolactam. The N-vinyl amide monomer may be present in the radiation-curable composition at a concentration from 0.1-40 wt %, or from 2-10 wt %.

The radiation-curable coating composition may include one or more monofunctional (meth)acrylate monomers in an amount from 5-95 wt %, or from 0-75 wt %, or from 40-65 wt %. The radiation-curable coating composition may include one or more monofunctional aliphatic epoxy (meth)acrylate monomers in an amount from 5-40 wt %, or from 10-30 wt %.

The radiation-curable component of the coating composition may include a hydroxyfunctional monomer. A hydroxyfunctional monomer is a monomer that has a pendant hydroxy moiety in addition to other reactive functionality such as (meth)acrylate. Examples of hydroxyfunctional monomers including pendant hydroxyl groups include caprolactone acrylate (available from Dow Chemical as TONE M-100); poly(alkylene glycol) mono(meth)acrylates, such as poly(ethylene glycol) monoacrylate, polypropylene glycol) monoacrylate, and poly(tetramethylene glycol) monoacrylate (each available from Monomer, Polymer & Dajac Labs); 2-hydroxyethyl (meth)acrylate, 3-hydroxypropyl (meth)acrylate, and 4-hydroxybutyl (meth)acrylate (each available from Aldrich (Milwaukee, Wis.).

The hydroxyfunctional monomer may be present in the radiation-curable coating composition in an amount between about 0.1 wt % and about 25 wt %, or in an amount between about 5 wt % and about 8 wt %. The use of the hydroxyfunctional monomer may decrease the amount of adhesion promoter necessary for adequate adhesion of the primary coating to the optical fiber. The use of the hydroxyfunctional monomer may also tend to increase the hydrophilicity of the primary coating. Hydroxyfunctional monomers are described in more detail in U.S. Pat. No. 6,563,996, the disclosure of which is hereby incorporated by reference in its entirety.

The total monomer content of the radiation-curable coating composition may be between about 5 wt % and about 95 wt %, or between about 30 wt % and about 75 wt %, or between about 40 wt % and about 65 wt %.

The radiation-curable component may include a monofunctional or multifunctional oligomer. The oligomer may be a (meth)acrylate-terminated oligomer. The oligomer may include polyether acrylates (e.g., GENOMER 3456, available from Rahn USA (Aurora, Ill.)), polyester acrylates (e.g., EBECRYL 80, 584 and 657, available from Cytec Industries Inc. (Woodland Park, N.J.)), or polyol acrylates. The oligomer may be a di(meth)acrylate, tri(meth)acrylate, tetra(meth)acrylate, or higher (meth)acrylate. Polyol (meth)acrylates may include polyalkoxy(meth)acrylates.

The oligomer of the curable primary coating composition may include a soft block with a number average molecular weight (Mₙ) of about 4000 g/mol or greater. Examples of such oligomers are described in U.S. patent application Ser. No. 09/916,536, the disclosure of which is incorporated by reference herein in its entirety. The oligomers may have flexible backbones, low polydispersities, and/or may provide cured coatings of low crosslink densities.

The oligomers may be used singly, or in combination to control coating properties. The total oligomer content of the radiation-curable coating composition may be between about 5 wt % and about 95 wt %, or between about 25 wt % and about 65 wt %, or between about 35 wt % and about 55 wt %.

In one embodiment, the acrylic copolymer is a block copolymer that includes two or more blocks, where each block is based on a repeat unit derived from a different acrylic monomer. A copolymer block based on a repeat unit derived from an acrylic monomer may be referred to herein as an acrylic block. The acrylic copolymer lacks urethane groups, lacks urea groups, and lacks radiation-curable groups. The acrylic copolymer is non-reactive with other components of the coating composition. In one embodiment, the acrylic copolymer is a block copolymer with at least two blocks in which all blocks are based on a repeat unit derived from an acrylic monomer and blocks based on at least two different acrylic monomers are present.

Homopolymers formed from the acrylic monomers from which the two or more acrylic blocks of the acrylic copolymer are derived differ in glass transition temperature (T_{g}). It is recognized that the T_{g} of the homopolymer formed from an acrylic monomer may vary with the molecular weight of the homopolymer. It is further recognized, however, that the T_{g} of a homopolymer generally stabilizes and levels off above some threshold molecular weight. When referring to the T_{g} of the homopolymer of the acrylic monomers of the present acrylic copolymer herein, it is intended that the homopolymer has a molecular weight above the threshold needed to achieve a stabilized T_{g}. In one embodiment, the homopolymer of the monomer used to form a block of the acrylic copolymer has a T_{g} above room temperature and the homopolymer of the monomer used to form a different block of the acrylic copolymer has a T_{g} below room temperature. Blocks of the acrylic copolymer based on repeat units derived from an acrylic monomer having a homopolymer with a T_{g} above the temperature of deployment of a fiber coated with a coating formed from the present coating composition may be referred to herein as “hard” blocks. Blocks of the acrylic copolymer based on repeat units derived from an acrylic monomer having a homopolymer with a T_{g} below the temperature of deployment of a fiber coated with a coating formed from the present coating composition may be referred to herein as “soft” blocks. The temperature of deployment of the coated fiber may be room temperature. Reference may be made herein to the T_{g} of a block of the present acrylic copolymer. When referring to the T_{g} of a block, it is understood that the T_{g} refers to the T_{g} of the homopolymer of the acrylic monomer from which the repeat unit of the block is derived.

The acrylic copolymer may include acrylic blocks that differ in T_{g} by at least 40° C., or at least 60° C., or at least 80° C., or at least 100° C., or at least 120° C. The acrylic copolymer may include an acrylic block having a T_{g} above 50° C. and an acrylic block having a T_{g} below 0° C. The acrylic copolymer may include an acrylic block having a T_{g} above 50° C. and an acrylic block having a T_{g} below −20° C. The acrylic copolymer may include an acrylic block having a T_{g} above 50° C. and an acrylic block having a T_{g} below −35° C. The acrylic copolymer may include an acrylic block having a T_{g} above 50° C. and an acrylic block having a T_{g} below −55° C. The acrylic copolymer may include an acrylic block having a T_{g} above 70° C. and an acrylic block having a T_{g} below 0° C. The acrylic copolymer may include an acrylic block having a T_{g} above 70° C. and an acrylic block having a T_{g} below −20° C. The acrylic copolymer may include an acrylic block having a T_{g} above 70° C. and an acrylic block having a T_{g} below −35° C. The acrylic copolymer may include an acrylic block having a T_{g} above 70° C. and an acrylic block having a T_{g} below −55° C. The acrylic copolymer may include an acrylic block having a T_{g} above 90° C. and an acrylic block having a T_{g} below 0° C. The acrylic copolymer may include an acrylic block having a T_{g} above 90° C. and an acrylic block having a T_{g} below −20° C. The acrylic copolymer may include an acrylic block having a T_{g} above 90° C. and an acrylic block having a T_{g} below −35° C. The acrylic copolymer may include an acrylic block having a T_{g} above 90° C. and an acrylic block having a T_{g} below −55° C.

In one embodiment, the acrylic copolymer includes three acrylic blocks in which two higher T_{g} or hard blocks are separated by one lower T_{g} or soft block.

Acrylic copolymers in accordance with the present disclosure include two or more acrylic blocks, where each acrylic block has a repeat unit derived from a different acrylic monomer. The acrylic copolymer may include acrylic blocks derived from two or more acrylic monomers, or three or more acrylic monomers, or four or more acrylic monomers, etc. The acrylic copolymer may be linear or branched and may include crosslinks. The composition, number of repeat units in each block, number of blocks, relative proportions and ordering of different acrylic blocks can be varied to control the properties of the acrylic copolymer and the properties of cured coatings formed from compositions that include the acrylic copolymer.

The acrylic copolymer may include multiple higher T_{g} acrylic blocks and multiple lower T_{g} acrylic blocks. The higher T_{g} and lower T_{g} acrylic blocks may be alternating in the structure of the acrylic copolymer, arranged randomly, or arranged arbitrarily. The structure of the acrylic copolymer may include two or more consecutive higher T_{g} acrylic blocks, two or more consecutive lower T_{g} acrylic blocks, or combinations of two or more consecutive higher T_{g} acrylic blocks and two or more consecutive lower T_{g} acrylic blocks. The different higher T_{g} acrylic blocks may be derived from the same or different acrylic monomers and may include the same or different number of repeat units. The different lower T_{g} acrylic blocks may be derived from the same or different acrylic monomers and may include the same or different number of repeat units. In one embodiment, the acrylic copolymer is a block copolymer that includes acrylic blocks derived from methylmethacrylate and acrylic blocks derived from butylacrylate, where the methylmethacrylate blocks have higher T_{g} than the butylacrylate blocks. An acrylic block located at or closest to each terminus of the acrylic copolymer may be referred to as a terminal block or terminal acrylic block. Acrylic blocks positioned between terminal acrylic blocks may be referred to herein as interior blocks or interior acrylic blocks. In one embodiment, the acrylic copolymer includes three or more acrylic blocks, two of which are terminal acrylic blocks, where the terminal acrylic blocks have higher T_{g} values than the interior acrylic blocks.

The acrylic copolymer may function as a strength additive and may provide an increase in the tensile strength of coatings formed from the present radiation-curable coating composition.

Acrylic monomers that may be used to form acrylic blocks of the acrylic copolymer include alkylacrylates and alkylmethacrylates. Representative acrylic monomers include methylmethacrylate, ethylmethacrylate, n-propylmethacrylate, n-butylmethacrylate, isobutylmethacrylate, isopropylmethacrylate, hexylmethacrylate, dodecylmethacrylate, 2-ethylhexylmethacrylate, isobornylmethacrylate, methylacrylate, ethylacrylate, n-propylacrylate, isopropylacrylate, n-butylacrylate, isobutylacrylate, hexylacrylate, dodecylacrylate, 2-ethylhexylacrylate, and isobornylacrylate. Acrylic monomers that are expected to provide acrylic blocks with high T_{g} include methylmethacrylate, ethylmethacrylate, and isobornyl(meth)acrylate. Acrylic monomers that are expected to provide acrylic blocks with low T_{g} include n-butylacrylate, 2-ethylhexylacrylate, and dodecylmethacrylate.

Acrylic co-polymers may be prepared by techniques such as free-radical polymerization, RAFT (reversible addition-fragmentation chain transfer polymerization), ATRP (atom transfer radical polymerization), living polymerization, or anionic polymerization from two or more acrylic monomers. The polymerization reaction may include an initiator and may be carried out in bulk mixtures of the co-monomers or with co-monomers in the presence of a solvent. The polymerization reaction may also be carried out in emulsion or suspension processes in aqueous media.

The molecular weight of the acrylic co-polymer is selected to maintain an acceptable viscosity of the coating composition. If the molecular weight of the acrylic co-polymer is too high, the viscosity of the coating composition is high and the coating composition is difficult to process. To maintain an acceptable viscosity, the number average molecular weight (Mₙ) of the acrylic co-polymer may be less than or equal to 100,000 and the weight average molecular weight (M_{w}) of the acrylic co-polymer may be less than or equal to 200,000. The number average molecular weight of the acrylic copolymer may be between 5,000 g/mol and 100,000 g/mol, or between 10,000 g/mol and 80,000 g/mol, or between 20,000 g/mol and 70,000 g/mol, or between 25,000 g/mol and 60,000 g/mol. The ratio of weight average molecular weight to number average molecular weight is referred to herein as the polydispersity index. The polydispersity index of the acrylic copolymer may be between 1.2 and 2.7, or between 1.5 and 2.5, or between 1.7 and 2.3, or between 1.9 and 2.1.

The relative proportion or concentration of a block in the acrylic copolymer may be expressed in terms of the weight percent (wt %) of the block in the acrylic polymer. When used in reference to the concentration of blocks with a repeat unit derived from a particular acrylic monomer, wt % refers to percent by weight of all blocks derived from the particular acrylic monomer in the acrylic copolymer. The mass of the acrylic copolymer is the basis for wt % when referring herein to the concentration of blocks. It is noted that more than one block with a repeat unit derived from a particular acrylic monomer may be present in the acrylic copolymer. In this instance, the concentration refers to the combined wt % of all blocks derived from the particular acrylic monomer that are present in the acrylic copolymer.

The acrylic copolymer may contain acrylic blocks derived from two chemically distinct acrylic monomers, where the T_{g} of homopolymers derived from the two acrylic monomers differ so that the acrylic copolymer includes one or more lower T_{g} blocks and one or more higher T_{g} blocks. The concentration of higher T_{g} blocks in the acrylic copolymer may be between 5 wt % and 60 wt %, or between 10 wt % and 50 wt %, or between 20 wt % and 40 wt %. The concentration of lower T_{g} blocks in the acrylic copolymer may be between 40 wt % and 95 wt %, or between 45 wt % and 80 wt %, or between 40 wt % and 60 wt %, or between 60 wt % and 80 wt %. The summed wt % of the higher T_{g} blocks and the lower T_{g} blocks may be 100%.

It is believed that an acrylic copolymer may become dispersed in the polymer network formed when the radiation-curable components of the coating composition react with one another during UV curing. Dispersal of the acrylic copolymer may provide physical entanglements or other local interactions that act to increase the strength of the coating. The chemical compatibility of the acrylic copolymers with common radiation-curable monofunctional and multifunctional (meth)acrylate monomers, oligomers, and crosslinkers leads to high solubility of the present acrylic copolymers in radiation-curable coating compositions. The high solubility permits incorporation of high concentrations of the acrylic copolymer in the coating formulation and affords a wider range of control over the properties of cured coatings formed from the coating formulations. Unlike the thermoplastic urethane elastomers of the prior art, the present acrylic copolymers are soluble in a wide range of radiation-curable acrylate coating compositions. Coating compositions need not be limited to highly polar or non-polar radiation-curable (meth)acrylate components and may include (meth)acrylate components of intermediate or moderate polarity. The present acrylic copolymers are soluble, for example, in the radiation-curable monomer diluent ethoxylated(4)nonylphenol acrylate, which is known to facilitate fast curing of coating compositions.

The acrylic copolymer may be present in the coating composition in an amount from 5-40 wt %, or from 10-30 wt %, or from 10-25 wt %, or from 15-25 wt %.

Suitable photoinitiators for the radiation-curable coating composition include 1-hydroxycyclohexylphenyl ketone (e.g., IRGACURE 184 available from BASF)); bis(2,6-dimethoxybenzoyl)-2,4,4-trimethylpentylphosphine oxide (e.g., commercial blends IRGACURE 1800, 1850, and 1700 available from BASF); 2,2-dimethoxy-2-phenylacetophenone (e.g., IRGACURE 651, available from BASF); bis(2,4,6-trimethylbenzoyl)-phenylphosphine oxide (IRGACURE 819); (2,4,6-trimethylbenzoyl)diphenyl phosphine oxide (LUCIRIN TPO, available from BASF); ethoxy(2,4,6-trimethylbenzoyl)-phenylphosphine oxide (LUCIRIN TPO-L from BASF); and combinations thereof. The photoinitiator may be present in an amount from 0.5 wt % to 5.0 wt %, or from 1.0 wt % to 3.0 wt %.

In one embodiment, the coating composition includes 5-40 wt % of one or more non-radiation-curable acrylic copolymers, 0.5-10 wt % of one or more multifunctional radiation-curable components, 40-80 wt % of one or more monofunctional radiation-curable components, and 0.5-5.0 wt % of photoinitiator.

In a second embodiment, the radiation-curable coating composition may include 5-40 wt. % of one or more acrylic block copolymers, 5-80 wt. % of one or more monofunctional (meth)acrylate monomers, 5-40 wt. % of one or more multifunctional (meth)acrylate monomers (or oligomers), and up to 5 wt. % of photoinitiator.

In a third embodiment, the radiation-curable coating composition may include 10-30 wt. % of one or more acrylic block copolymers, 30-80 wt. % of one or more monofunctional (meth)acrylate monomers, 5-35 wt. % of one or more multifunctional (meth)acrylate monomers (or oligomers), and up to 5 wt. % of photoinitiator.

In a fourth embodiment, the radiation-curable coating composition may include 10-25 wt. % of one or more acrylic block copolymers, 50-80 wt. % of one or more monofunctional (meth)acrylate monomers, 10-30 wt. % of one or more multifunctional (meth)acrylate monomers (or oligomers), and up to 5 wt. % of photoinitiator.

In a fifth embodiment, the radiation-curable coating composition may include 10-25 wt. % of one or more acrylic block copolymers, 60-80 wt. % of one or more monofunctional (meth)acrylate monomers, 5-25 wt. % of one or more multifunctional (meth)acrylate monomers (or oligomers), and up to 5 wt. % of photoinitiator.

The coating composition may optionally include one or more non-radiation-curable components in addition to the non-radiation-curable acrylic copolymer. The one or more optional non-radiation-curable components may include linear or branched urethane oligomers of the type shown in formula (Ia) or (Ib) below:

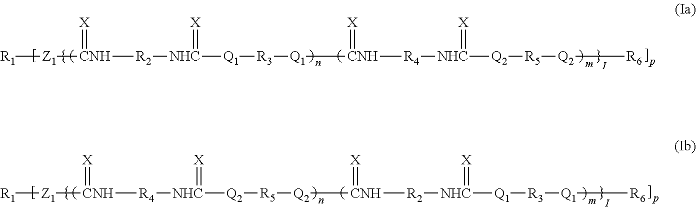

in which,

R₁ is a core moiety of a multifunctional reactant, where the number of functional groups of the core moiety is defined by p, where p is 2 or greater;

each X is independently S or O;

Z₁ is —O—, —S—, —N(H)—, or —N(alkyl)-, preferably —O— or —N(H)—;
each of Q₁ and Q₂ is independently —O—, —S—, —N(H)—, or —N(alkyl)-, preferably —O— or —N(H)—;

each of R₂ and R₄ is a core moiety of a di(thio)isocyanate reactant;

R₃ is a core moiety of a polyol or amine-capped polyol reactant;

R₅ is a hydrocarbon or oxygen-containing hydrocarbon having an average molecular weight of between about 28 to about 400;

R₆ is represented by the structure according to formula (II) or (III)

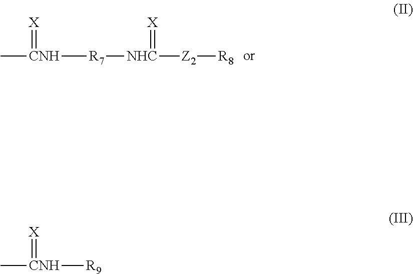

where X is defined as above, Z₂ is —O—, —S—, —N(H)—, or —N(alkyl)-, preferably —O— or —N(H)—, R₇ is a core moiety of a di(thio)isocyanate reactant, R₈ is a non-radiation curable capping agent, and R₉ is a core moiety of an isocyanate or thioisocyanate reactant;

l is 1 to 6;
m is greater than or equal to 0, preferably 1 to 4, more preferably 1 to 3; and

n is greater than or equal to 1, preferably 2 to 10, more preferably 2 to 6.

The core moiety (R₁) present in the non-radiation curable component is the reaction product of a multifunctional core reactant. The functional groups can be hydroxyl groups or amino groups. Preferably, the multifunctional core reactant is a polyol or an amine-capped polyol. Examples of these core reactants and their number of functional groups (p) include, without limitation, glycerol, where p=3; trimethylol propane, where p=3; pentaerythritol, where p=4; ditrimethylol propane, where p=4; ethylenediamine tetrol, where p=4; xylitol, where p=5; dipentaerythritol, where p=6; sucrose and other disaccharides, where p=8; alkoxylated derivatives thereof; dendrimers where p is from about 8 to about 32, such as poly(amidoamine) (PAMAM) dendrimers with G1 (p=8), G2 (p=16), or G3 (p=32) amine groups or PAMAM-OH dendrimers with G1 (p=8), G2 (p=16), or G3 (p=32) hydroxyl groups; and combinations thereof.

R₂, R₄, and R₇ independently represent the core moiety of a di(thio)isocyanate reactant. This includes both diisocyanates and dithioisocyanates, although diisocyanates are preferred. Although any diisocyanates and dithioisocyanates can be used, preferred R₂, R₄, and R₇ core groups of these diisocyanates and dithioisocyanates include the following:

| Reactant Name | R₂ or R₄ or R₇ Core Moiety |
|---|---|
| 4,4′-methylene bis(cyclohexyl) diisocyanate (HMDI) | 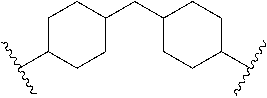 [SMILES: *C1CCC(CC2CCC(*)CC2)CC1] |
| toluene diisocyanate (TDI) | 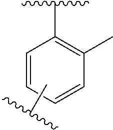 |
| Isophorone diisocyanate (IPDI) | 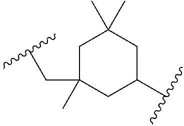 [SMILES: *CC1(C)CC(*)CC(C)(C)C1] |
| Tetramethyl-1,3-xylylene diisocyanate (XDI) | 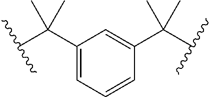 [SMILES: *C(C)(C)c1cccc(C(*)(C)C)c1] |
| 4,4′-methylene bis(phenyl) diisocyanate (MDI) | 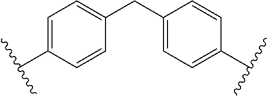 [SMILES: *c1ccc(Cc2ccc(*)cc2)cc1] |
| p-phenylene diisocyanate (PDI) | 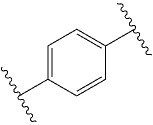 [SMILES: *c1ccc(*)cc1] |
| Alkyl diisocyanates | —(CH₂)_{q}— where q is 2 to 12, preferably 6 |

R₃ is a core moiety of a polyol or amine-capped polyol reactant that preferably has a number average molecular weight of greater than or equal to about 400. In certain embodiments, the polyol or amine-capped polyol has a number average molecular weight between about 1000 and about 9000, between about 2000 and 9000, or between about 4000 and 9000. Examples of suitable R₃-forming polyols include, without limitation, polyether polyols such as poly(propylene glycol) [PPG], poly(ethylene glycol) [PEG], poly(tetramethylene glycol) [PTMG] and poly(1,2-butylene glycol); polycarbonate polyols; polyester polyols; hydrocarbon polyols such as hydrogenated poly(butadiene) polyols; amine-capped derivatives of these polyols, and any combinations thereof.

R₅ is a hydrocarbon or oxygen-containing hydrocarbon, which is preferably saturated, and has an average molecular weight of between about 28 to about 400. Thus, R₅ is the core moiety of a low molecular weight diol (to form urethane linkages) or diamine (to form urea linkages) reactant that acts analogously to a chain extender in a polyurethane. Exemplary reactants include, without limitation, 1,4-butanediol, 1,6-butanediol, ethylene diamine, 1,4-butanediamine, and 1,6-hexanediamine. As noted above, these chain extender based urethane or urea groups are expected to result in “hard block” areas along the block moiety branch(es) that promote more effective hydrogen bonding branch interactions than would the simple urethane (or urea) linkages resulting from polyol (or amine capped polyol)/isocyanate links. Where m is 0, the hard block is not present.

R₈ is the reaction product of a non-radiation curable capping agent, which caps the reactive isocyanate group at the end of a block moiety branch. These agents are preferably monofunctional alcohols (or amines) that will react with residual isocyanate groups at the end of a branch. Examples of these reactants include, without limitation, 1-butanol, 1-octanol, polypropylene glycol) monobutyl ether, and 2-butoxyethanol.

R₉ is a core moiety of an (thio)isocyanate reactant. Any suitable mono-functional (thio)isocyanate can be used for this purpose. Exemplary (thio)isocyanate reactants that can serve as non-reactive capping agent for an arm of the component include, without limitation, methyl isocyanate, ethyl isocyanate, n-propyl isocyanate, i-propyl isocyanate, n-butyl isocyanate, i-butyl isocyanate, n-pentyl isocyanate, n-hexyl isocyanate, n-undecylisocyanate, chloromethyl isocyanate, β-chloroethyl isocyanate, γ-chloropropyl isocyanate, ethoxycarbonylmethyl isocyanate, β-ethoxyethyl isocyanate, α-ethoxyethyl isocyanate, α-butoxyethyl isocyanate, α-phenoxyethylisocyanate, cyclopentyl isocyanate, cyclohexyl isocyanate, methyl isothiocyanate, and ethyl isothiocyanate.

The one or more optional non-radiation-curable components may include non-radiation-curable acrylic polymers lacking the block structure of the present acrylic copolymers. The non-radiation-curable acrylic polymer may be a random copolymer formed from two or more acrylic monomers. Representative examples include associative acrylic polymers that incorporate one or more types of monomers with a hydrogen-donating group and/or one or more types of monomers with a hydrogen-accepting group. The co-monomers may include (meth)acrylates or acrylamides. The (meth)acrylate or acrylamide co-monomers may include chemical groups that participate in hydrogen bonding. The chemical groups may include hydrogen bond donor groups or hydrogen bond acceptor groups. Hydrogen bond donor groups may include N—H, O—H or —CO₂H groups. Hydrogen bond acceptor groups may include carbonyl groups, ether groups, or nitrogen. The hydrogen-bonding groups may be present along the backbone of the polymer formed from the co-monomers or in pendent groups of the polymer formed from the co-monomers. The (meth)acrylate co-monomers may include polar groups. The polar groups may be present along the backbone of the polymer formed from the co-monomers or in pendent groups of the polymer formed from the co-monomers. Hydrogen bond donor groups, hydrogen bond acceptor groups, and polar groups present in one or more of the co-monomers may enable self-association of the co-polymer formed from the co-monomers.

The optional associative acrylic polymer may be formed from a reaction between two or more (meth)acrylate co-monomers. The co-monomers may interact weakly or strongly with each other or other co-monomers. Co-monomers with weaker interactions may include esters of (meth)acrylic acid. Representative co-monomers with weaker interactions include:

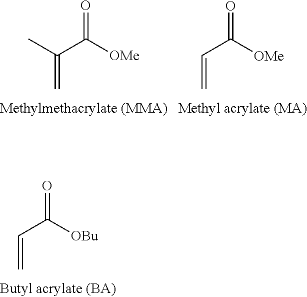

Other monomers with weaker interactions include (1) α,β-unsaturated esters: for example, ethyl acrylate (or methacrylate), propyl acrylate (or methacrylate), butyl acrylate (or methacrylate), pentyl acrylate (or methacrylate), hexyl acrylate (or methacrylate), heptyl acrylate (or methacrylate), octyl acrylate (or methacrylate), nonyl acrylate (or methacrylate), decyl acrylate (or methacrylate), undecyl acrylate (or methacrylate), dodecyl acrylate (or methacrylate), tridecyl acrylate (or methacrylate), tetradecyl acrylate (or methacrylate), pentadecyl acrylate (or methacrylate), hexadecyl acrylate (or methacrylate), heptadecyl acrylate (or methacrylate), octadecyl acrylate (or methacrylate), nonadecyl acrylate (or methacrylate), icosyl acrylate (or methacrylate), and their corresponding structural isomers or halogated derivatives, ethylene (or propylene) glycol methyl ether acrylates (or methacrylates), poly(ethylene (or propylene) glycol) methyl ether acrylates, isobornyl acrylate, benzyl acrylate (or methacrylate) and their derivatives (or methacrylates); (2) Alkyl vinyl ethers: for example, methyl vinyl ether, ethyl vinyl ether, propyl vinyl ether, butyl vinyl ether, pentyl vinyl ether, hexyl vinyl ether, heptanyl vinyl ether, octyl vinyl ether, nonyl vinyl ether, decyl vinyl ether, undecyl vinyl ether, dodecyl vinyl ether, tridecyl vinyl ether, tetradecyl vinyl ether, pentadecyl vinyl ether, hexadecyl vinyl ether, heptadecyl vinyl ether, and their corresponding structural isomers; (3) acrylonitrile; and (4) unsaturated hydrocarbons: for example, ethylene, propylene, butylene, hexene, or octene.

Co-monomers with stronger interactions for an optional associative acrylic polymer may include (meth)acrylamides, N-vinyl (meth)acrylamides, N-vinyl amide, (meth)acrylic acid, or α,β-unsaturated lactones and amides. Representative co-monomers with stronger interactions include:

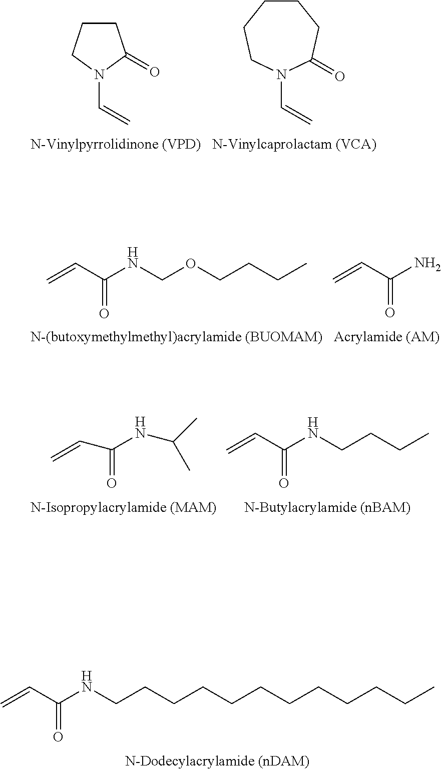

N-Vinylpyrrolidinone (VPD) may also be referred to herein as N-Vinylpyrrolidone.

The nitrogens in N-Vinylpyrrolidone and N-Vinylcaprolactam may function as hydrogen bond acceptor groups. The N—H groups of N-(Butoxymethylmethyl)acrylamide (BUOMAM), acrylamide (AM), N-Isopropylacrylamide (MAM), N-Butylacrylamide (nBAM), N-Dodecylacrylamide (nDAM), and other N-substituted acrylamides may function as hydrogen bond donor groups. The carbonyl groups may function as hydrogen bond acceptor groups. Methylmethacrylate (MMA), methyl acrylate (MA), and butyl acrylate (BA) lack hydrogen bond donor groups.

Other monomers with stronger interactions that may be included in the optional associative acrylic polymer include: N,N-dialkyl(meth)acrylamide; α,β-unsaturated monomers with a hydrogen bond donor group including (1) α,β-unsaturated amides: acrylamide (or methacrylamide): for example, N-methyl acrylamide (or methacrylamide), N-ethyl acrylamide (or methacrylamide), N-propyl acrylamide (or methacrylamide), N-butyl acrylamide (or methacrylamide), N-pentyl acrylamide (or methacrylamide), N-hexyl acrylamide (or methacrylamide), N-heptanyl acrylamide (or methacrylamide), N-octyl acrylamide (or methacrylamide), N-nonyl acrylamide (or methacrylamide), N-decyl acrylamide (or methacrylamide), N-undecyl acrylamide (or methacrylamide), N-dodecyl acrylamide (or methacrylamide), N-tridecyl acrylamide (or methacrylamide), N-tetradecyl acrylamide (or methacrylamide), N-pentadecyl acrylamide (or methacrylamide), N-hexadecyl acrylamide (or methacrylamide), N-heptadecyl acrylamide (or methacrylamide), N-octadecyl acrylamide (or methacrylamide), N-nonadecyl acrylamide (or methacrylamide), N-icosyl acrylamide (or methacrylamide), and their corresponding structural isomers, N-(Butoxymethyl)acrylamide, N-(hydroxymethyl)acrylamide; 2) acrylic acid and carboxylate-functionalized α,β-unsaturated esters: for example, 2-carboxyethyl acrylate; 2-carboxyethyl acrylate oligomers; and (3) hydroxyl-functionalized α,β-unsaturated esters: hydroxypropyl acrylate, 4-hydroxybutyl acrylate.

In addition to the radiation-curable component(s) (which may include one or more monofunctional or multifunctional monomer(s), oligomer(s), and crosslinkers as described hereinabove), acrylic copolymer(s), and polymerization initiator(s), the curable coating composition may include other additives such as an adhesion promoter, a strength additive, a reactive diluent, an antioxidant, a catalyst, a stabilizer, an optical brightener, a property-enhancing additive, an amine synergist, a wax, a lubricant, and/or a slip agent. Some additives may operate to control the polymerization process, thereby affecting the physical properties (e.g., modulus, glass transition temperature) of the cured coating formed from the radiation-curable composition. Other additives may affect the integrity of the cured coating formed from the radiation-curable coating composition (e.g., protect against de-polymerization or oxidative degradation).

Another aspect of the present disclosure relates to a method of making an optical fiber, where the method includes forming a coating on the glass (core+cladding) portion of the fiber using a radiation-curable composition that includes an acrylic copolymer in accordance with the present disclosure.

The core and cladding of the coated fibers may be produced in a single-step operation or multi-step operation by methods that are well known in the art. Suitable methods include: the double crucible method, rod-in-tube procedures, and doped deposited silica processes, also commonly referred to as chemical vapor deposition (“CVD”) or vapor phase oxidation. A variety of CVD processes are known and are suitable for producing the core and cladding layer used in the coated optical fibers of the present invention. They include external CVD processes, axial vapor deposition processes, modified CVD (MCVD), inside vapor deposition, and plasma-enhanced CVD (PECVD).

The glass portion of the coated fibers may be drawn from a specially prepared, cylindrical preform which has been locally and symmetrically heated to a temperature sufficient to soften the glass, e.g., a temperature of about 2000° C. for a silica glass. As the preform is heated, such as by feeding the preform into and through a furnace, a glass fiber is drawn from the molten material. See, for example, U.S. Pat. Nos. 7,565,820; 5,410,567; 7,832,675; and 6,027,062; the disclosures of which are hereby incorporated by reference herein, for further details about fiber making processes.

The radiation-curable composition of the present disclosure may be applied to the glass portion of the coated fiber after it has been drawn from the preform. The radiation-curable composition may be applied immediately after cooling. The radiation-curable composition may then be cured to form a solidified coating to produce a coated optical fiber. The method of curing may be thermal, chemical, or radiation-induced, such as by exposing the radiation-curable composition to an appropriate energetic source, such as ultraviolet light, actinic radiation, microwave radiation, or an electron beam, after the composition has been applied to the glass portion of the fiber. The appropriate form of initiation energy may depend on the coating compositions and/or polymerization initiator employed. Methods of applying layers of radiation-curable compositions to a moving glass fiber are disclosed in U.S. Pat. Nos. 4,474,830 and 4,585,165, the disclosures of which are hereby incorporated by reference herein.

### Examples

A series of coating compositions using various non-radiation-curable acrylic block copolymers in combination with one or more radiation-curable components, and a photoinitiator was prepared. Some compositions included one or more optional additives or components.

The acrylic block copolymers presented in the coating compositions of this example included blocks with repeat units derived from the monomers methylmethacrylate and n-butylacrylate. The acrylic block copolymers have the general structure shown below, where PMMA refers to a block of repeat units derived from the methylmethacrylate monomer and PnBA refers to a block of repeat units derived from the n-butylacrylate monomer. The PMMA blocks are the higher T_{g} acrylic blocks and the PnBA block is the lower T_{g} acrylic block. The PMMA blocks are terminal acrylic blocks and the PnBA block is an interior acrylic block.

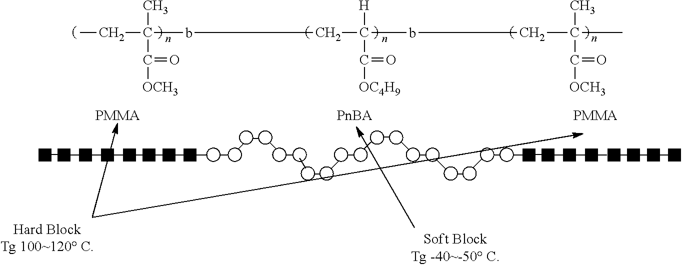

Samples of several PMMA-PnBA acrylic block copolymers with the block configuration shown above were obtained from different commercial suppliers. Samples LA2250, LA2140E, and LA2330 were obtained from Kuraray (U.S. Headquarters in Houston, Tex.). Samples M53 and M52N were obtained from Arkema (U.S. Headquarters in King of Prussia, Pa.). The relative proportions of n-butylacrylate (nBA) and methylmethacrylate (MMA) monomers (in wt % based on the mass of the acrylic copolymer), number average molecular weight (Mₙ) (g/mol), and weight average molecular weight (M_{w}) (g/mol) for each sample are summarized in Table 1 below. Sample M52N included acrylamide (AAm) monomer in addition to nBA and MMA monomers. Acrylamide includes hydrogen-donating nitrogen groups that may provide interactions that strengthen cured coatings made from the composition.

TABLE 1
Acrylic Block Copolymers

| | wt % | wt % | wt % | | | |
|---|---|---|---|---|---|---|
| Sample | nBA | MMA | AAm | M_{w} | Mₙ | M_{w}/Mₙ |
| LA2250 | 70 | 30 | 0 | 48600 | 35700 | 1.36 |
| LA2140E | 77 | 23 | 0 | 52700 | 40700 | 1.29 |
| LA2330 | 78 | 22 | 0 | 77400 | 55900 | 1.39 |
| M53 | 51 | 49 | 0 | 150000 | 65200 | 2.30 |
| M52N | 51 | 39 | 10 | 115700 | 36400 | 3.18 |

Table 2 lists the coating compositions (A-N) that were prepared using the acrylic block copolymers listed in Table 1:

TABLE 2
Coating Compositions

| Coating | |
|---|---|
| Composition | Components |
| A | 20 wt % LA2250 |
| | 69 wt % SR504 |
| | 5 wt % SR495 |
| | 3 wt % SR306 |
| | 3 wt % TPO |
| | 1 pph Irganox 1035 |
| B | 30 wt % LA2140E |
| | 32 wt % SR504 |
| | 23 wt % CD9075 |
| | 5 wt % SR495 |
| | 7 wt % SR508 |
| | 3 wt % TPO |
| | 1 pph Irganox 1035 |
| C | 30 wt % LA2140E |
| | 55 wt % CD9075 |
| | 5 wt % SR495 |
| | 7 wt % SR508 |
| | 3 wt % TPO |
| | 1 pph Irganox 1035 |
| D | 30 wt % LA2140E |
| | 45 wt % CD9075 |
| | 10 wt % SR506 |
| | 5 wt % SR495 |
| | 7 wt % SR508 |
| | 3 wt % TPO |
| | 1 pph Irganox 1035 |
| E | 20 wt % LA2330 |
| | 20 wt % SR504 |
| | 50 wt % CD9075 |
| | 5 wt %SR495 |
| | 2 wt % SR351 |
| | 3 wt % TPO |
| | 1 pph Irganox 1035 |
| F | 20 wt % LA2250 |
| | 67 wt % SR504 |
| | 5 wt % SR495 |
| | 5 wt % SR306 |
| | 3 wt % TPO |
| | 1 pph Irganox 1035 |
| G | 30 wt % LA2140E |
| | 23 wt % CD9075 |
| | 32 wt % SR504 |
| | 5 wt % SR495 |
| | 5 wt % SR508 |
| | 3 wt % TPO |
| | 1 pph Irganox 1035 |
| H | 10 wt % M53 |
| | 75 wt % CD9075 |
| | 5 wt % SR495 |
| | 7 wt % SR508 |
| | 3 wt % TPO |
| | 1 pph Irganox 1035 |
| I | 10 wt % M52N |
| | 10 wt % Linear NR Urethane |
| | 65 wt % CD9075 |
| | 5 wt % SR495 |
| | 7 wt % SR508 |
| | 3 wt % TPO |
| | 1 pph Irganox 1035 |
| J | 10 wt % M52N |
| | 10 wt % PBA |
| | 65 wt % CD9075 |
| | 5 wt % SR495 |
| | 7 wt % SR508 |
| | 3 wt % TPO |
| | 1 pph Irganox 1035 |
| K | 20 wt % LA2250 |
| | 12 wt % PBA |
| | 55 wt % SR504 |
| | 5 wt % SR495 |
| | 5 wt % SR306 |
| | 3 wt % TPO |
| | 1 pph Irganox 1035 |
| L | 20 wt % LA2250 |
| | 6 wt % PBA |
| | 61 wt % SR504 |
| | 5 wt % SR495 |
| | 5 wt % SR306 |
| | 3 wt % TPO |
| | 1 pph Irganox 1035 |
| M | 10 wt % LA2250 |
| | 25 wt % Branched NR Urethane |
| | 50 wt % SR504 |
| | 5 wt % SR495 |
| | 5 wt % SR306 |
| | 3 wt % TPO |
| | 1 pph Irganox 1035 |
| N | 20 wt % LA2250 |
| | 12 wt % Linear NR Urethane |
| | 55 wt % SR504 |
| | 5 wt % SR495 |
| | 5 wt % SR306 |
| | 3 wt % TPO |
| | 1 pph Irganox 1035 |

In the compositions, SR504 is ethoxylated (4) nonylphenol acrylate (Sartomer USA (Exton, Pa.)); SR495 is caprolactone acrylate (Sartomer USA (Exton, Pa.)); SR306 is triproplyleneglycol diacrylate (Sartomer USA (Exton, Pa.)); CD9075 is tetraethoxylated lauryl acrylate (Sartomer USA (Exton, Pa.)); SR508 is dipropylene glycol diacrylate (Sartomer USA (Exton, Pa.)); SR506 is isobornyl acrylate (Sartomer USA (Exton, Pa.)); SR 351 is trimethylolpropane triacrylate (Sartomer USA (Exton, Pa.); linear NR urethane is a linear non-reactive urethane having the formula:

C₄H₉O(CH₂)₂O˜(H12MDI˜P4000)₂˜H12MDI˜O(CH₂)₂OC₄H₉,

where P4000 is a polypropylene glycol moiety with a number average molecular weight of about 4000 and H12MDI is 4,4′-methylene bis(cyclohexyl)diisocyanate; PBA is polybutylacrylate (Acronal 4F, BASF); and branched NR urethane is a branched non-reactive urethane having the formula:

C[CH₂(PO)₂˜IPDI˜P1200˜IPDI˜BD˜IPDI˜P1200˜IPDI˜O(CH₂)₂OC₄H₉]₄

where PO is propylene oxide, IPDI is isophorone diisocyanate, BD is 1,4-butanediol, and P1200 is a polypropylene glycol moiety with a number average molecular weight of about 1200. TPO is ((2,4,6-trimethylbenzoyl)-diphenyl phosphine oxide) and functions as a photoinitiator (BASF). Irganox 1035 is thiodiethylene bis[3-(3,5-di-tert-butyl-4-hydroxyphenyl)propionate] and functions as an antioxidant (Ciba Specialty Chemical).

Coatings in the form of cured films were formed from the compositions given in Table 2. The cured films were prepared with the listed components using commercial blending equipment. Each coating composition was prepared by combining all components except for the TPO photoinitiator and Irganox 1035 anti-oxidant. The components were weighed into a jacketed beaker and heated to 60° C.-70° C. Blending was continued until a homogeneous mixture was obtained. The TPO photoinitiator and Irganox 1035 anti-oxidant were then weighed and added to the beaker. Blending was then continued until a homogeneous mixture was obtained. Films were prepared by drawing down the blended compositions on a glass plate using a 5 mil draw down bar. Films were cured using a Fusion D lamp with a nitrogen purge. The films received a dose of approximately 1350 mJ/cm². All samples were allowed to condition overnight in a controlled environment at 23° C. and 50% relative humidity.

The Young's modulus, tensile strength and % elongation of cured films formed from the radiation-curable compositions of Table 2 were measured. Tensile properties were measured using a Sintech MTS tensile tester. Tensile tests followed ASTM882-97. The gauge length used for testing was 5.1 cm and the test speed was 2.5 cm/minute. Tensile strength, % strain at break, and Young's Modulus values were recorded. T_{g} values of films formed from compositions A and B were determined to be −15° C. and −25° C., respectively, from the tan δ peak in a DMA measurement (1 Hz oscillation frequency and 1° C./min scan rate).

The measured characteristics of the cured films prepared from each of the compositions A-N are shown in Table 3 below, where each cured film is listed by the identification number of its coating composition (as listed in Table 2).

TABLE 3
Cured Film Tensile Properties

| | Young's | Tensile | |
|---|---|---|---|
| Cured | Modulus | Strength | % |
| Film | (MPa) | (MPa) | Elongation |
| A | 0.67 ± 0.04 | 0.43 ± 0.03 | 87 ± 4 |
| B | 0.92 ± 0.01 | 0.74 ± 0.03 | 122 ± 6 |
| C | 0.49 ± 0.05 | 0.36 ± 0.03 | 132 ± 24 |
| D | 0.51 ± 0.02 | 0.54 ± 0.04 | 126 ± 7 |
| E | 0.42 ± 0.06 | 0.31 ± 0.03 | 116 ± 10 |
| F | 0.78 ± 0.20 | 0.45 ± 0.11 | 71 ± 9 |
| G | 0.43 ± 0.02 | 0.46 ± 0.05 | 147 ± 9 |
| H | 1.08 ± 0.11 | 0.38 ± 0.09 | 51 ± 10 |
| I | 0.78 ± 0.01 | 0.30 ± 0.05 | 48 ± 7 |
| J | 0.53 ± 0.01 | 0.31 ± 0.03 | 129 ± 9 |
| K | 0.64 ± 0.05 | 0.40 ± 0.06 | 82 ± 9 |
| L | 0.85 ± 0.08 | 0.50 ± 0.07 | 77 ± 7 |
| N | 0.76 ± 0.06 | 0.28 ± 0.06 | 45 ± 8 |

The results indicate that the films exhibited low Young's modulus while retaining good tensile strength and elongation properties. Coatings formed from the present radiation-curable compositions are projected to perform well as primary coatings for optical fibers.

Cured films formed from the present radiation-curable compositions may have a Young's modulus less than 1.5 MPa, or less than 1.25 MPa, or less than 1.0 MPa, or less than 0.85 MPa, or less than 0.70 MPa, or less than 0.55 MPa, or less than 0.45 MPa and may also have a tensile strength greater than 0.25 MPa, or greater than 0.45 MPa, or greater than 0.65 MPa and a glass transition temperature T_{g} of less than 0° C., or less than −10° C., or less than −20° C. In one embodiment, a cured film formed from the present radiation-curable compositions has a Young's modulus less than 1 MPa, a T_{g} less than −10° C., a tensile strength greater than 0.5 MPa, and elongation at break greater than 100%.

Coating composition B was prepared on a larger scale for drawing on fiber. The T_{g} of the coating formed from composition B was determined to be −20.5° C. from the tan δ value of a DMA test. Fiber was drawn using composition B as the primary coating composition. A secondary coating was also formed over the primary coating formed from composition B. Coating were formed by UV curing and coated fibers using conventional silica glass fibers (core+cladding) were successfully drawn at speeds of 40 m/s. The degree of cure of composition B was observed to be 94.7±3.8%. The coated fibers exhibited low microbend losses at 1550 nm and 1625 nm.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. An optical fiber coating composition comprising:
a radiation-curable component;
a photoinitiator; and
a non-radiation-curable acrylic copolymer, said acrylic copolymer lacking urethane groups and urea groups, said acrylic copolymer comprising a first acrylic block and a second acrylic block, said first acrylic block including repeat units derived from a first acrylic monomer, said second acrylic block including repeat units derived from a second acrylic monomer, said second acrylic monomer differing from said first acrylic monomer.

2. The coating composition of claim 1, wherein a homopolymer formed from said first acrylic monomer has a first glass transition temperature and a homopolymer formed from said second acrylic monomer has a second glass transition temperature, said first glass transition temperature exceeding said second glass transition temperature by at least 50° C.

3. The coating composition of claim 2, wherein said first glass transition temperature exceeds said second glass transition temperature by at least 80° C.

4. The coating composition of claim 2, wherein said radiation-curable component includes a monofunctional acrylate monomer.

5. The coating composition of claim 4, wherein said radiation-curable component further includes a multifunctional acrylate monomer or a multifunctional acrylate oligomer.

6. The coating composition of claim 5, wherein the concentration of said acrylic copolymer is between 5 wt % and 40 wt %.

7. The coating composition of claim 6, wherein the concentration of said monofunctional acrylate monomer is between 40 wt % and 80 wt % and the concentration of said multifunctional acrylate monomer or said multifunctional acrylate oligomer is between 0.5 wt % and 10 wt %.

8. The coating composition of claim 7, wherein said first acrylic monomer is methyl methacrylate and said second acrylic monomer is butyl acrylate.

9. The coating composition of claim 8, wherein the concentration of said first acrylic block in said acrylic copolymer is between 10 wt % and 50 wt % and the concentration of said second acrylic block in said acrylic copolymer is between 40 wt % and 95 wt %.

10. The coating composition of claim 1, further comprising a linear or branched urethane oligomer of the type shown in formula (Ia) or (Ib) below: 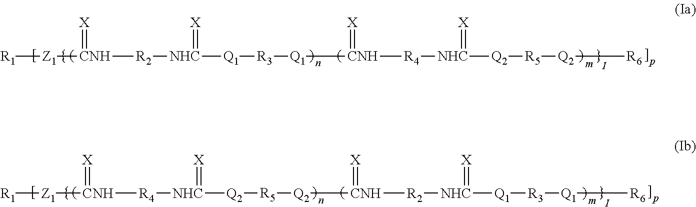
wherein,
R₁ is a core moiety of a multifunctional reactant, where the number of functional groups of the core moiety is defined by p, where p is 2 or greater;
each X is independently S or O;
Z₁ is —O—, —S—, —N(H)—, or —N(alkyl)-;
each of Q₁ and Q₂ is independently —O—, —S—, —N(H)—, or —N(alkyl);
each of R₂ and R₄ is a core moiety of a di(thio)isocyanate reactant;
R₃ is a core moiety of a polyol or amine-capped polyol reactant;
R₅ is a hydrocarbon or oxygen-containing hydrocarbon having an average molecular weight of between about 28 to about 400;
R₆ is represented by the structure according to formula (II) or (III) 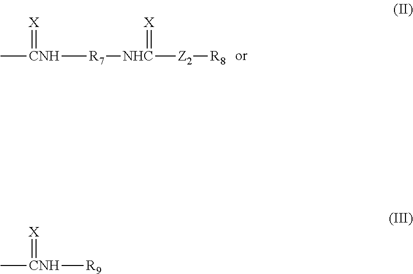
where X is defined as above, Z₂ is —O—, —S—, —N(H)—, or —N(alkyl), R₇ is a core moiety of a di(thio)isocyanate reactant, R₈ is a non-radiation curable capping agent, and R₉ is a core moiety of an isocyanate or thioisocyanate reactant;
l is 1 to 6;
m is greater than or equal to 0; and
n is greater than or equal to 1.

11. The coating composition of claim 1, further comprising a random acrylic copolymer.

12. The coating composition of claim 1, wherein said acrylic copolymer further includes a third acrylic block, said third acrylic block including repeat units derived from a third acrylic monomer.

13. The coating composition of claim 12, wherein said third acrylic monomer is the same as said first acrylic monomer.

14. The coating composition of claim 13, wherein said first acrylic block and said third acrylic block are terminal acrylic blocks.

15. The coating composition of claim 14, wherein a homopolymer formed from said first acrylic monomer has a first glass transition temperature and a homopolymer formed from said second acrylic monomer has a second glass transition temperature, said first glass transition temperature exceeding said second glass transition temperature by at least 50° C.

16. The coating composition of claim 15, wherein said first acrylic monomer is methyl methacrylate and said second acrylic monomer is butyl acrylate.

17. A cured product formed from an optical fiber coating composition comprising:
a radiation-curable component;
a photoinitiator; and
a non-radiation-curable acrylic copolymer, said acrylic copolymer lacking urethane groups and urea groups, said acrylic copolymer comprising a first acrylic block and a second acrylic block, said first acrylic block including repeat units derived from a first acrylic monomer, said second acrylic block including repeat units derived from a second acrylic monomer, said second acrylic monomer differing from said first acrylic monomer.

18. The cured product of claim 17, wherein the cured product has a Young's modulus less than 1 MPa, a T_{g} less than −10° C., and a tensile strength greater than 0.5 MPa.

19. A coated optical fiber comprising:
an optical fiber; and
a coating surrounding the fiber, said coating comprising the cured product of a coating composition comprising:
a radiation-curable component;
a photoinitiator; and
a non-radiation-curable acrylic copolymer, said acrylic copolymer lacking urethane groups and urea groups, said acrylic copolymer comprising a first acrylic block and a second acrylic block, said first acrylic block including repeat units derived from a first acrylic monomer, said second acrylic block including repeat units derived from a second acrylic monomer, said second acrylic monomer differing from said first acrylic monomer

20. A process of coating an optical fiber comprising:
providing an optical fiber;
applying a coating composition to said optical fiber, said coating composition comprising:
a radiation-curable component;
a photoinitiator; and
a non-radiation-curable acrylic copolymer, said acrylic copolymer lacking urethane groups and urea groups, said acrylic copolymer comprising a first acrylic block and a second acrylic block, said first acrylic block including repeat units derived from a first acrylic monomer, said second acrylic block including repeat units derived from a second acrylic monomer, said second acrylic monomer differing from said first acrylic monomer;
and
curing the coating composition.
